(19) United States
(12) Patent Application Publication
(10) Pub. No.: US 2005/0160000 A1
(43) Pub. Date: Jul. 21, 2005

(54) Electronic couponing of benefits

(76) Inventor: Norman J. Plourde, Cumming, GA (US)

Correspondence Address: HANES & SCHUTZ, P.C., 102 S. TEJON ST., SUITE 800, COLORADO SPRINGS, CO, 80903, US

(21) Appl. No.: 10/761,824

(22) Filed: Jan. 20, 2004

(51) Int. Cl. G06F 17/60

(52) U.S. Cl. 705/14

(57) ABSTRACT

Electronic coupons are generated representative of benefits for which a customer is eligible. The benefits available to the customer are discovered. At least one transaction product is discovered. Each transaction product is identified for which benefits are available to the customer. The value of the benefit is calculated for the identified products. An electronic coupon is issued for the value of the benefit.

### FIELD OF THE INVENTION

This invention relates in general to electronic couponing and, more particularly, electronic couponing of benefits.

### BACKGROUND OF THE INVENTION

Under the guidance of various government agencies, programs such as Woman, Infants, and Children (WIC) provide supplemental food services to pregnant, breastfeeding, and postpartum woman and children up to the age of five. WIC benefits are authorized through local clinics and given to the participant in a prescription format that allows only specific categories of food items to be redeemed. Traditionally, these benefits have been recorded on paper. The tracking of paper is time consuming, imprecise, and subject to fraud.

Several efforts to replace government-issued paper benefits are known. These approaches involve calculating the cash value of the redeemed food items, and applying the value of the electronic benefits as a form of tender (payment) for the food items. The tender approach has several disadvantages. When the benefits are recorded as tender, the tendering process must take into account which items fall under that tender type. For a program like WIC, the tendering process becomes very complex, when compared to a “cash-equivalent” tender such as credit cards or gift certificates. The tender process necessarily involves more changes to the computer software at the merchant. Under the tender process, it is more difficult to properly account for discounts already applied to the redeemed food item. The tender process must involve complicated calculations of tax and tax credits, since taxes are generally not charged on the government-issued benefits.

State agencies contract with merchants to provide food products to the WIC participants. Electronic coupons are becoming widespread in the retail environment. In lieu of traditional paper coupons, merchants and manufacturers are increasingly issuing discounts in electronic form. Conventionally, these coupons apply to single product or manufacturer's family of products.

Alternatively, many merchants have loyalty programs where a customer can receive discounts by presenting evidence of membership in the loyalty program. The merchant issues electronic coupons to cause a discount to be applied to certain items in a retail purchase.

Traditionally, electronic coupons are part of advertising and incentive programs. The programs may be targeted at a membership group, such as a discount club, or the customers of a specific merchant. Often, electronic coupons are stored as part of special coupon-only repositories and coupon redemption information is collected for marketing purposes.

### SUMMARY OF THE INVENTION

According to principles of the present invention, in one embodiment, electronic coupons are generated representative of benefits for which a customer is eligible. The benefits available to the customer are discovered. At least one transaction product is discovered. Each transaction product is identified for which benefits are available to the customer. The value of the benefit is calculated for the identified products. An electronic coupon is issued for the value of the benefit.

### DESCRIPTION OF THE DRAWINGS

FIG. 1 is a block diagram illustrating a transaction system including one embodiment of the present invention system for generating electronic coupons.

FIG. 2 is a diagram illustrating one embodiment of information flow between components of the system illustrated in FIG. 1.

FIG. 3 is a flow chart illustrating one embodiment of the present invention method for generating electronic coupons.

FIG. 4 is a flow chart illustrating an alternate embodiment of the present invention method for generating electronic coupons.

FIG. 5 is a flow chart illustrating another embodiment of the present invention method for generating electronic coupons.

### DETAILED DESCRIPTION OF THE INVENTION

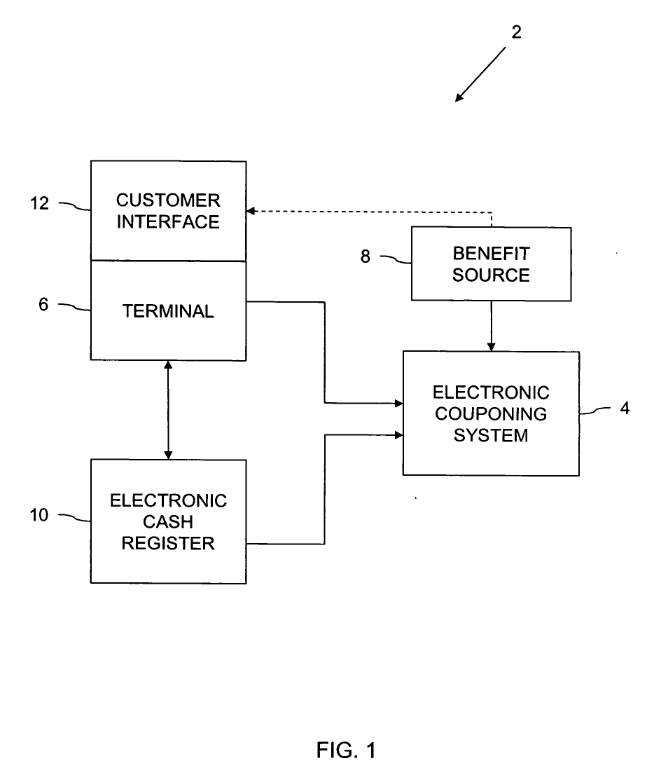

FIG. 1 illustrates a transaction system 2 including one embodiment of electronic couponing system 4. In one embodiment, transaction system 2 includes electronic couponing system 4, terminal 6, benefit source 8, and electronic cash register 10.

Electronic couponing system 4 generates electronic coupons representative of benefits for which a customer is eligible. An indication of the benefits available to the customer is stored on benefit source 8.

In one embodiment, benefit source 8 is a smart card. A smart card is any portable memory device having data capable of being read from and written to. An indication of the benefits is stored on the smart card and reduced as they are redeemed.

In an alternative embodiment, benefit source 8 is an online service. The online service stores the indication of the benefits, which is accessed by electronic couponing device 4. The customer is identified and the identity of the customer is transmitted to the online service to discover the benefits available to the customer. The customer may be identified in any manner. For example, the customer may be identified by using a personal identification number (PIN), a magnetic swipe card, a smart card, or any combination of these.

Terminal 6 includes customer interface 12, which allows input to be provided by a customer and optionally, provides feedback to the customer. Terminal 6 communicates with electronic couponing system 4 and electronic cash register 10 as needed to provide information to and from customer interface 12.

Electronic cash register 10 processes the sale transaction between a customer and a merchant. Electronic cash register 10 identifies a price for each item sold and totals the price. Electronic cash register 10 requests coupons from electronic couponing device 4 and, when electronic couponing device 4 returns the electronic coupons, reduces the total price according to the electronic coupons.

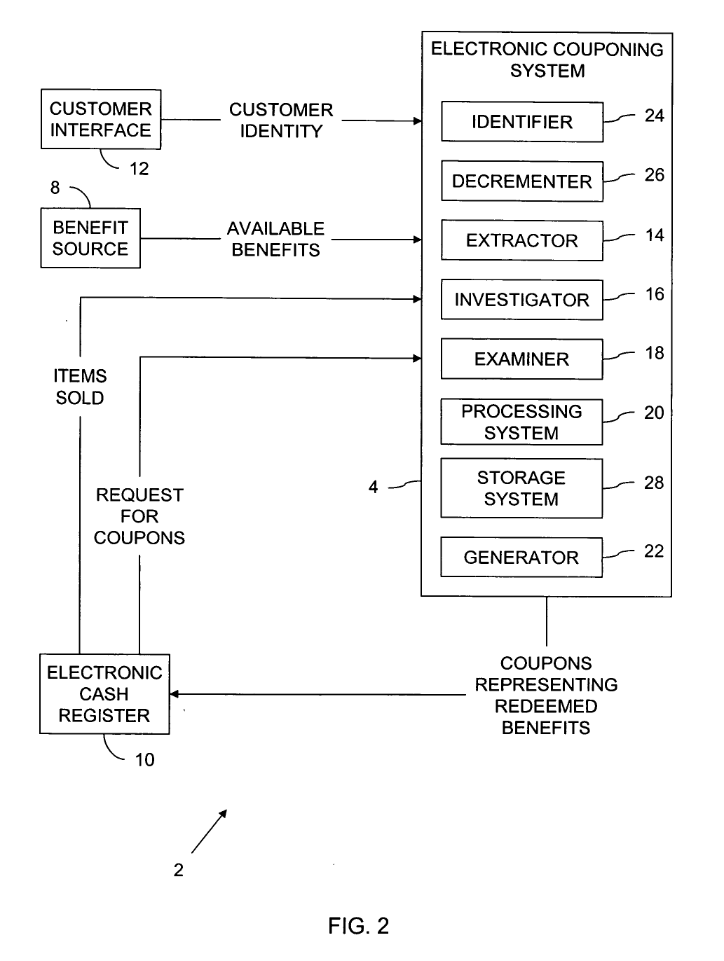

FIG. 2 illustrates electronic couponing device 4 more fully and shows information flow between components of transaction system 2. In one embodiment, electronic couponing system 4 includes extractor 14, investigator 16, examiner 18, processing system 20, generator 22, and optionally identifier 24, decrementer 26, and storage system 28.

Extractor 14 is any combination of hardware and executable code configured to discover, from benefit source 8, the benefits available to the customer. In one embodiment, benefit source 8 includes a smart card and extractor 14 is configured to discover, from the smart card, the benefits available to the customer. Extractor 14 communicates the benefits available to the customer with Examiner 18.

Investigator 16 is any combination of hardware and executable code configured to discover at least one transaction product. In one embodiment, investigator 16 discovers the at least one transaction product from electronic cash register 10. A transaction product is the goods or services purchased.

Examiner 18 is any combination of hardware and executable code configured to identify each transaction product for which benefits are available to the customer. In one embodiment, examiner 18 applies the indication of benefits available to the customer from extractor 14 to each transaction product to identify which of the transaction products for which benefits are available to the customer.

Processing system 20 is any combination of hardware and executable code configured to calculate the value of the benefit for the identified products. In one embodiment, processing system 20 is configured to independently calculate the value of the benefit for each identified product. In an alternative embodiment, processing system 20 is configured to calculate the total value of the benefit for all identified products.

Although pictured and discussed as separate from processing system 20, extractor 14, investigator 16, examiner 18, generator 22, identifier 24, and decrementer 26 are alternatively integral with or have portions integral with processing system 20.

The value of the benefit is passed from processing system 20 to generator 22. Generator 22 is any combination of hardware and executable code configured to issue an electronic coupon for the value of the benefit.

Identifier 24 is any combination of hardware and executable code configured to identify the customer. The identity of the customer is passed to extractor 14. In one embodiment, benefit source 8 includes an online service and extractor 14 is configured to discover, from the identity of the customer and the online service, the benefits available to the customer.

Decrementer 26 is any combination of hardware and executable code configured to reduce the benefits for which the customer is eligible by the amount of the electronic coupon. In one embodiment, decrementer 26 reduces the benefits available to the customer by modifying the indication of benefits stored on a smart card. In an alternative embodiment, decrementer 26 reduces the benefits available to the customer by modifying the indication of benefits stored on an online service.

Storage system 28 is any device or system configured to store data or executable code. Storage system 28 may also be a program storage system tangibly embodying a program, applet, or instructions executable by processing system 20 for performing the method steps of the present invention executable by processing system 20. In one embodiment, portions of one or all of extractor 14, investigator 16, examiner 18, generator 22, identifier 24, and decrementer 26 are stored on storage system 28. Storage system 28 may be any type of storage media such as magnetic, optical, or electronic storage media.

Storage system 28 is illustrated in FIG. 1 as a single device. Alternatively, storage system 28 may include more than one device. Furthermore, each device of storage system 28 may be embodied in a different media type. For example, one device of storage system 28 may be a magnetic storage media while another device of storage system 28 is an electronic storage media.

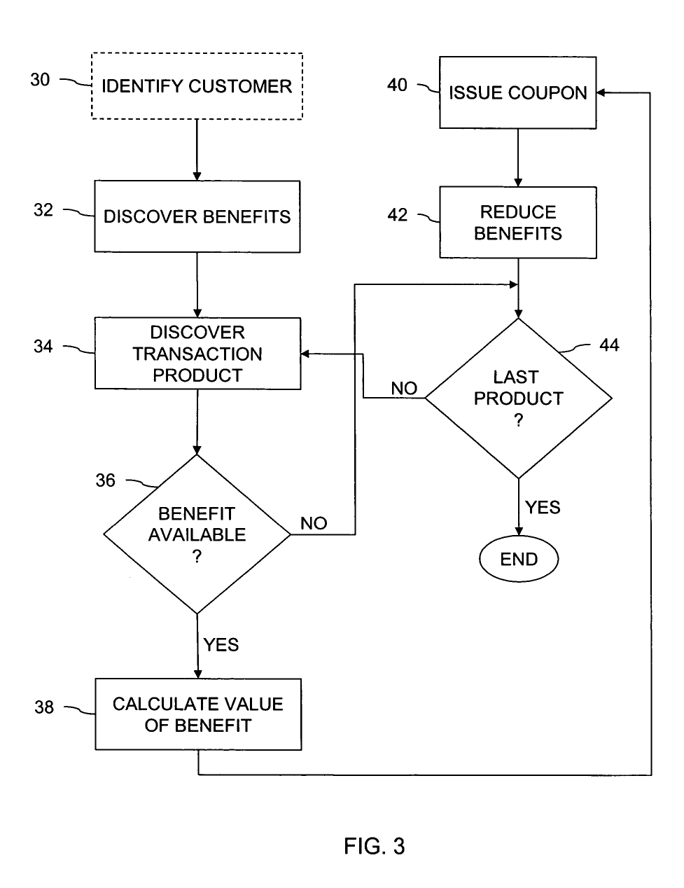

FIGS. 3-5 are a flow chart representing steps of different embodiment of the present invention. Although the steps represented in FIG. 3-5 are presented in a specific order, the present invention encompasses variations in the order of steps. FIGS. 3-5 illustrate some of these possible variations. Furthermore, additional steps may be executed between the steps illustrated in FIG. 3-5 without departing from the scope of the present invention.

In one embodiment, the customer is identified 30. In other embodiments, the customer identity is not necessary and is the customer is not identified.

The benefits available to the customer are discovered 32. The available benefits are discovered in any manner. In one embodiment, an indication of the benefits is stored on a smart card and the benefits available to the customer are discovered 32 from the smart card.

In an alternative embodiment, an indication of the benefits is stored on an online service and the benefits available to the customer are discovered 32 from the online service. In one embodiment, the identity of the customer is used to discover the benefits from the online service.

At least one transaction product is discovered 34. The transaction products may be discovered 34 by any means. In one embodiment, the transaction products are discovered 34 from electronic cash register 10.

Each transaction product is identified 36 for which benefits are available to the customer. For each transaction product, a decision is made 36 whether benefits are available for that transaction product.

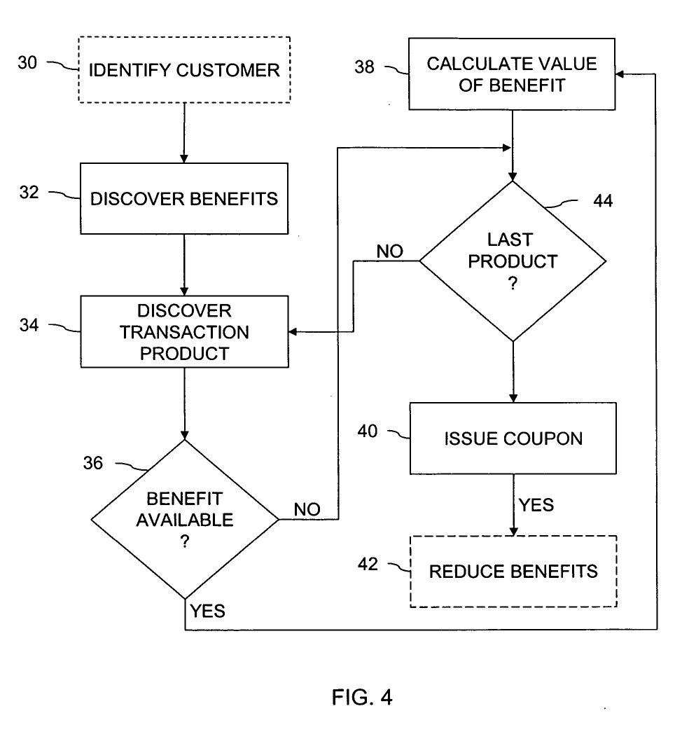

In one embodiment, shown in FIGS. 3 and 4, if a benefit is available for the transaction product, a value of the benefit is calculated 38 for the identified product. The value of the benefit is independently calculated 38 for each identified product.

In one embodiment, shown in FIG. 3, an electronic coupon is then issued 40 for each transaction product in the amount of the value of the benefit and, optionally, the benefits for which the customer is eligible are reduced 42 by the transaction product. The coupon is issued 40, not as a marketing effort based on a particular brand of product, but rather based on whether the particular type of product is eligible for benefits. Additionally, the coupons are generally available for use by all merchants who contract to provide the benefit on behalf of the government. There is no “membership” with the merchant necessary on the part of the beneficiary.

In one embodiment, an indication of the benefits is stored on a smart card and benefits for which the customer is eligible are reduced 42 by modifying the indication on the smart card.

In an alternative embodiment, an indication of the benefits is stored on an online service and benefits for which the customer is eligible are reduced 42 by modifying the indication on the online service.

A check is then made 44 to determine whether the transaction product was the last transaction product of the sale transaction. If so, the sale is finalized. If not, the next transaction product is discovered 34. The steps repeat until the last transaction product has been processed and the transaction is finalized.

In one embodiment, shown in FIG. 4, the electronic coupon is not issued 40 and the benefits are not reduced 42 until the last product has been processed.

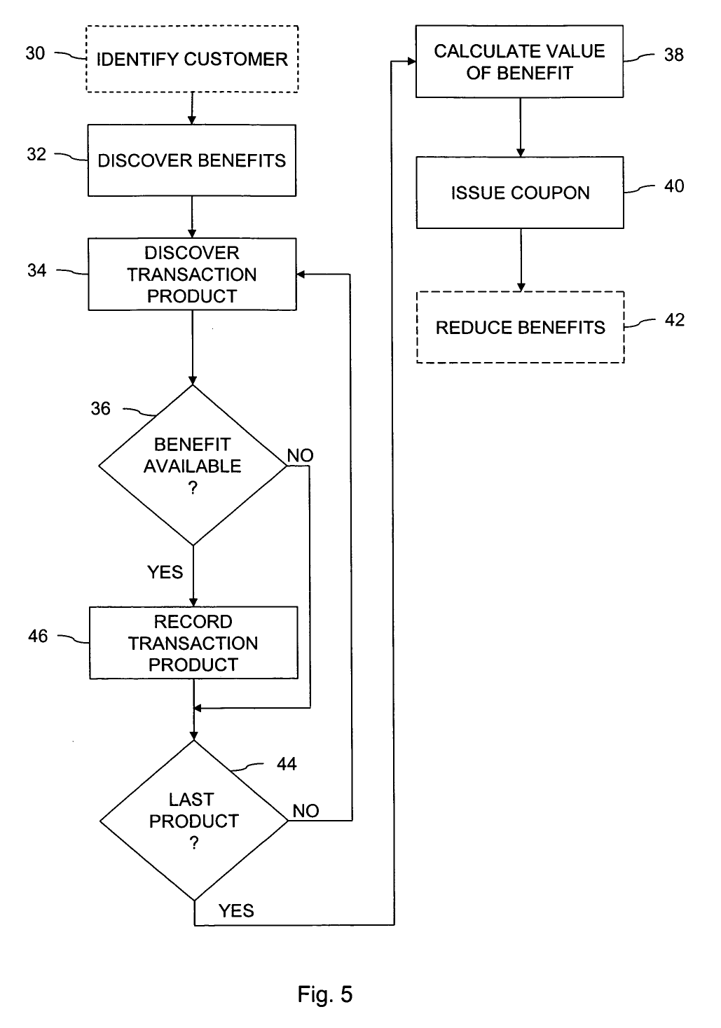

In an alternate embodiment, shown in FIG. 5, if a benefit is available for the transaction product, the transaction product is recorded 44. The total value of the benefit for all identified products is calculated 38 after the last product has been processed. Then the electronic coupon is issued 40 and the benefits are reduced 42.

In one example of this invention in practice, electronic couponing device 4 is incorporated into a WIC program. Although the description of this invention is being illustrated for the WIC program, it is applicable to other types of benefits programs.

A WIC recipient goes to an authorized grocery store and selects one or more prescription food items. At the checkout, the WIC recipient inserts a WIC card into the point-of-sale device and enters a PIN. The grocer's system validates the cardholder's PIN, and retrieves the benefit prescription from an online service.

As eligible food products are scanned, electronic couponing device 4 records the eligible products. The value of the eligible products is calculated 38 and a store coupon is issued 40 to reduce the balance due on the transaction. The electronic coupons are generated as necessary. The information from which the coupons are derived may be part of a larger data store regarding the beneficiary, such as health information, demographics, and immunization records.

The amount of remaining benefit is reduced 42. The coupons are collected, stored, and submitted to the government agency for payment. The coupon redemption information is used to collect payment for the merchant. The redemption information is also used by the government agencies to track the usage of the benefits.

By using a coupon technique for redeeming benefits, rather than a tender technique, this invention simplifies many issues by using readily available functions of electronic cash register 10.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

1. A method for generating electronic coupons representative of benefits for which a customer is eligible, the method comprising:
discovering the benefits available to the customer,
discovering at least one transaction product,
identifying each transaction product for which benefits are available to the customer,
calculating the value of the benefit for the identified products, and
issuing an electronic coupon in the amount of the value of the benefit.

2. The method of claim 1 wherein calculating the value of the benefit for the identified products includes independently calculating the value of the benefit for each identified product.

3. The method of claim 1 wherein calculating the value of the benefit for the identified products includes calculating the total value of the benefit for all identified products.

4. The method of claim 1 wherein discovering the benefits available to the customer includes discovering the benefits from a smart card.

5. The method of claim 1 further including identifying the customer.

6. The method of claim 2 wherein discovering the benefits available to the customer includes using the identity of the customer to discover the benefits from the identity of the customer and an online service.

7. The method of claim 1 further including reducing the benefits for which the customer is eligible by the transaction product.

8. A system for generating electronic coupons representative of benefits for which a customer is eligible, an indication of the benefits available to the customer stored on a benefit source, the system comprising:
an extractor configured to discover, from the benefit source, the benefits available to the customer;
an investigator configured to discover at least one transaction product;
an examiner configured to identify each transaction product for which benefits are available to the customer;
a processing system configured to calculate the value of the benefit for the identified products; and
a generator configured to issue an electronic coupon for the value of the benefit.

9. The system of claim 8 wherein the processing system is further configured to independently calculate the value of the benefit for each identified product.

10. The system of claim 8 wherein the processing system is further configured to calculate the total value of the benefit for all identified products.

11. The system of claim 8 wherein the benefit source includes a smart card and the extractor is configured to discover, from the smart card, the benefits available to the customer.

12. The system of claim 8 further including an identifier configured to identify the customer.

13. The system of claim 12 wherein the benefit source includes an online service and the extractor is configured to discover, from the identity of the customer and the online service, the benefits available to the customer

14. The system of claim 8 further including a decrementer configured to reduce the benefits for which the customer is eligible by the amount of the electronic coupon.

15. A system for generating electronic coupons representative of benefits for which a customer is eligible, an indication of the benefits available to the customer stored on a benefit source, the system comprising:
means for discovering, from the benefit source, the benefits available to the customer;
means for discovering at least one transaction product;
means for identifying each transaction product for which benefits are available to the customer;
means for calculating the value of the benefit for the identified products; and
means for issuing an electronic coupon for the value of the benefit.

16. The system of claim 15 wherein means for calculating the value of the benefit for the identified products includes means for calculating the value of the benefit for each identified product.

17. The system of claim 15 wherein means for calculating the value of the benefit for the identified products includes means for calculating the total value of the benefit for all identified products.

18. The system of claim 15 wherein the benefit source includes a smart card and wherein the means for discovering, from the benefit source, the benefits available to the customer includes means for discovering, from the smart card, the benefits available to the customer

19. The system of claim 15 further including means for identifying the customer.

20. The system of claim 19 wherein the benefit source includes an online service and the means for discovering, from the benefit source, the benefits available to the customer includes, means for discovering, from the identity of the customer and the online service, the benefits available to the customer

21. The system of claim 15 further including means for reducing the benefits for which the customer is eligible by the amount of the electronic coupon.

22. A program storage system readable by a computer, tangibly embodying a program, applet, or instructions executable by the computer to perform method steps for generating electronic coupons representative of benefits for which a customer is eligible, the method comprising:
discovering the benefits available to the customer,
discovering at least one transaction product,
identifying each transaction product for which benefits are available to the customer,
calculating the value of the benefit for the identified products, and
issuing an electronic coupon for the value of the benefit.

23. The program storage system of claim 22 wherein calculating the value of the benefit for the identified products includes independently calculating the value of the benefit for each identified product.

24. The program storage system of claim 22 wherein calculating the value of the benefit for the identified products includes calculating the total value of the benefit for all identified products.

25. The program storage system of claim 22 wherein discovering the benefits available to the customer includes discovering the benefits from a smart card.

26. The program storage system of claim 22 further including identifying the customer.

27. The program storage system of claim 26 wherein discovering the benefits available to the customer includes using the identity of the customer to discover the benefits from the identity of the customer and an online service.

28. The program storage system of claim 22 further including reducing the benefits for which the customer is eligible by the amount of the electronic coupon.
